(19) United States
(12) Patent Application Publication
(10) Pub. No.: US 2025/0181301 A1
(43) Pub. Date: Jun. 5, 2025

(54) DISPLAY SYSTEM AND DISPLAY METHOD

(71) Applicant: Optoma Corporation, New Taipei City (TW)

(72) Inventor: Jung-Chang Lin, New Taipei City (TW)

(73) Assignee: Optoma Corporation, New Taipei City (TW)

(21) Appl. No.: 18/929,623

(22) Filed: Oct. 29, 2024

(30) Foreign Application Priority Data
Dec. 4, 2023 (TW) 112146992

(51) Int. Cl. G06F 3/14; G06F 3/04842; G06F 3/0486

(52) U.S. Cl. CPC G06F 3/1454; G06F 3/04842; G06F 3/0486

(57) ABSTRACT

A display system and a display method are provided. The display system includes a display apparatus and a mobile device having a computing device and a display. The method includes: selecting a first presentation file from at least one presentation file according to a first user command and obtaining a first slide and first speaker notes corresponding to the first slide from the first presentation file by the computing device of the mobile device, wherein the display apparatus is for displaying the first slide and the display is for displaying a floating window and the first slide, and the floating window at least partially covers the first slide displayed on the display, wherein the floating window is for displaying the first speaker notes.

### CROSS-REFERENCE TO RELATED APPLICATION

This application claims the priority benefit of Taiwan application serial no. 112146992, filed on Dec. 4, 2023. The entirety of the above-mentioned patent application is hereby incorporated by reference herein and made a part of this specification.

### BACKGROUND

### Technical Field

The invention relates to a display system and a display method, and particularly relates to a display method for displaying slides and speaker's notes respectively and a display system suitable for the display method.

### Description of Related Art

When a speaker uses a laptop computer to read or edit a presentation file, the laptop computer may display a slide and speaker notes. The speaker may use the speaker notes to guide the presentation. However, when the laptop is communicatively connected to a projector, an interactive flat panel or an interactive whiteboard, taking the interactive flat panel as an example, since the notebook computer implements a screen mirroring function to allow the interactive flat panel displaying the same image with the notebook computer, when the interactive flat panel displays a slide of the notebook computer, neither the interactive flat panel nor the notebook computer may display the speaker notes.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure is directed to a display system and a display method, where when a mobile device executes a screen mirroring program, and when a display apparatus displays a slide, the mobile device may display the slide and speaker notes.

Other objectives, features and advantages of the disclosure will be further understood from the further technological features disclosed by the embodiments of the disclosure wherein there are shown and described preferred embodiments of this disclosure, simply by way of illustration of modes best suited to carry out the invention.

In order to achieve one or a portion of or all of the objects or other objects, an embodiment of the disclosure provides a display system including a display apparatus and a mobile device. The mobile device is communicatively connected to the display apparatus. The mobile device includes a computing device and a display. The display is electrically connected to the computing device, and the computing device is configured to select a first presentation file from at least one presentation file according to a first user command, and obtain a first slide and first speaker notes corresponding to the first slide from the first presentation file, wherein the display apparatus is configured to display the first slide, the display is configured to display a floating window and the first slide, and the floating window at least partially covers the first slide displayed on the display, wherein the floating window is configured to display the first speaker notes.

In an embodiment of the disclosure, the above-mentioned floating window covers a part of the first slide.

In an embodiment of the disclosure, the above-mentioned computing device is configured to receive a second user command, and the computing device is configured to move the floating window according to the second user command, wherein the moved floating window covers another part of the first slide.

In an embodiment of the disclosure, the above-mentioned second user command corresponds to a drag and drop operation.

In an embodiment of the disclosure, the above-mentioned computing device is configured to obtain a second slide and second speaker notes corresponding to the second slide from the first presentation file; and the computing device is configured to receive a second user command, and switch the first slide displayed on the display to the second slide and switch the first speaker notes displayed in the floating window to the second speaker notes according to the second user command.

In an embodiment of the disclosure, the above-mentioned display is configured to display the first slide and the floating window, wherein the floating window includes the topmost window.

In an embodiment of the disclosure, the above-mentioned computing device is configured to determine whether the display apparatus and the mobile device are in the same network; and in response to the display apparatus and the mobile device being in the same network, the mobile device is configured to communicatively connect with the display apparatus.

In order to achieve one or a portion of or all of the objects or other objects, an embodiment of the disclosure provides a display method adapted to a display system, the display system comprises a display apparatus and a mobile device having a computing device and a display. The display method comprises: selecting a first presentation file from at least one presentation file according to a first user command and obtaining a first slide and first speaker notes corresponding to the first slide from the first presentation file by the computing device of the mobile device, wherein the display apparatus is configured to display the first slide, and the display is configured to display a floating window and the first slide, and the floating window at least partially covers the first slide displayed on the display apparatus, wherein the floating window is configured to display the first speaker notes.

In an embodiment of the disclosure, the above-mentioned floating window covers a part of the first slide.

In an embodiment of the disclosure, the display method further includes: receiving a second user command by the computing device, and moving the floating window by the computing device according to the second user command, wherein the moved floating window covers another part of the first slide.

In an embodiment of the disclosure, the above-mentioned second user command corresponds to a drag and drop operation.

In an embodiment of the disclosure, the display method further includes: obtaining a second slide and second speaker notes corresponding to the second slide from the first presentation file by the computing device; and receiving a second user command by the computing device, switching the first slide displayed on the display apparatus to the second slide and switching the first speaker notes displayed in the floating window to the second speaker notes according to the second user command.

In an embodiment of the disclosure, the display is configured to display the first slide and the floating window, wherein the floating window includes the topmost window.

In an embodiment of the disclosure, the display method further includes: determining whether the display apparatus and the mobile device are in the same network by the computing device; and in response to the display apparatus and the mobile device being in the same network, communicatively connecting with the display apparatus by the computing device of the mobile device.

Based on the above description, the mobile device of the disclosure may retrieve the slide and the speaker notes from the first presentation file, and when the display apparatus displays the slide, the display of the mobile device may display the slide and the floating window, and the floating window displays the speaker notes for user reference.

### BRIEF DESCRIPTION OF THE DRAWINGS

The accompanying drawings are included to provide a further understanding of the invention, and are incorporated in and constitute a part of this specification. The drawings illustrate embodiments of the disclosure and, together with the description, serve to explain the principles of the invention.

FIG. 1 is a schematic diagram of a display system according to an embodiment of the disclosure.

FIG. 2 is a schematic diagram of a mobile device selecting a presentation file according to an embodiment of the disclosure.

FIG. 3 is a schematic diagram of a display of a display apparatus displaying a slide according to an embodiment of the disclosure.

FIG. 4 is a schematic diagram of a display of the mobile device displaying a slide and

a floating window according to an embodiment of the disclosure.

FIG. 5 is a schematic diagram of the display of the display apparatus displaying another slide according to an embodiment of the disclosure.

FIG. 6 is a schematic diagram of the display of the mobile device displaying another slide and a floating window according to an embodiment of the disclosure.

FIG. 7 is a schematic diagram of moving the floating window according to an embodiment of the disclosure.

FIG. 8 is a flowchart of a display method for displaying slides according to an embodiment of the disclosure.

### DESCRIPTION OF THE EMBODIMENTS

It is to be understood that other embodiment may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

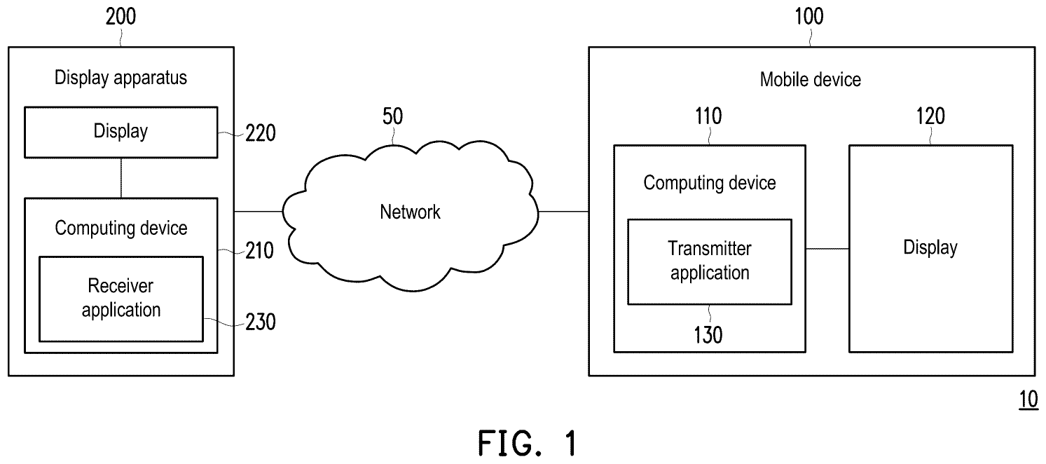

FIG. 1 is a schematic diagram of a display system 10 according to an embodiment of the disclosure. The display system 10 may include a mobile device 100 and a display apparatus 200. The mobile device 100 is, for example, a terminal device such as a personal computer, a notebook computer, a tablet computer, or a smartphone. The display apparatus 200 is, for example, an interactive flat panel, an interactive whiteboard, or a projector. The mobile device 100 may be communicatively connected to the display apparatus 200 through a network 50, where the network 50 includes, for example, a local area network or a mobile network.

The mobile device 100 may include a computing device 110 and a display 120, where the computing device 110 is electrically connected to the display 120. The computing device 110 is, for example, at least one processor, at least one central processing unit (CPU), a graphics processing unit (GPU), or other programmable general-purpose or special-purpose microprocessor, digital signal processor (DSP), programmable controller, application specific integrated circuits (ASIC), programmable logic device (PLD), other similar at least one processing chip or at least one circuit, or a combination of these devices. The display 120 of the mobile device 100 is, for example, an LED display panel, a liquid crystal display panel, or other types of display panels, but the disclosure is not limited thereto. The mobile device 100 further includes a communication device (such as various communication chips, mobile communication chips, Bluetooth chips or WiFi chips and multiple related circuits), a storage device (such as a removable random access memory, a flash memory or a hard drive) and an input interface device (such as a touch screen, a keyboard or a mouse), etc. The above hardware is electrically connected to the computing device 110. In an embodiment, the storage device of the mobile device 100 may store a transmitter application 130, the computing device 110 may access/retrieve the transmitter application 130 of the storage device, and the computing device 110 is configured to execute the transmitter application 130 to send a slide of a presentation file.

The display apparatus 200 includes a computing device 210 and a display 220, where the computing device 210 is electrically connected to the display 220. The hardware of the display apparatus 200 such as the computing device 210, the communication device, the storage device, and the input interface device are similar to the hardware of the mobile device 100, and details thereof will not be repeated. The above hardware is electrically connected to the computing device 210. In an embodiment, the storage device of the display apparatus 200 may store a receiver application 230, and the computing device 210 may access/retrieve the receiver application 230, and execute the receiver application 230 to receive the slide of the presentation file. The display 220 of the display apparatus 200 is, for example, an LED display panel, a liquid crystal display panel, other types of display panels, or an optical engine, where the optical engine is configured to project images on a screen or wall.

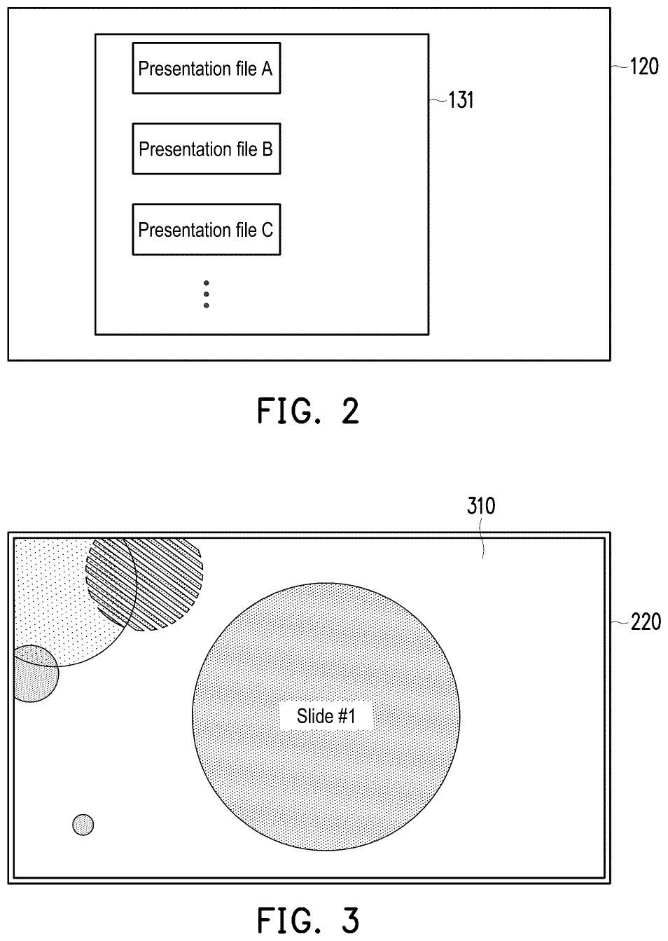

FIG. 2 is a schematic diagram of the mobile device 100 selecting a presentation file according to an embodiment of the disclosure. Through the network 50, a communication device of the mobile device 100 is communicatively connected with a communication device of the display apparatus 200. To further explain, the computing device 110 of the mobile device 100 executes the transmitter application 130 and is communicatively connected to the computing device 210 of the display apparatus 200 executing the receiver application 230 through the network 50. In an embodiment, the computing device 110 executes the transmitter application 130 to determine whether the display apparatus 200 and the mobile device 100 are in a same network. If the result of the determination is that the display apparatus 200 and the mobile device 100 are not in the same network, the transmitter application 130 cannot be communicatively connected to the receiver application 230 through the network 50. If the result of the determination is that the display apparatus 200 and the mobile device 100 are in the same network, the transmitter application 130 may be communicatively connected to the receiver application 230 through the network 50. The computing device 110 of the mobile device 100 may be communicatively connected to the computing device 210 of the display apparatus 200 to control the display apparatus 200. For example, the computing device 110 may control the display 220 of the display apparatus 200 to display a slide, and the slide is transmitted to the display apparatus 200 from the mobile device 100.

The computing device 110 of the mobile device 100 is configured to read one or a plurality of presentation files from the storage device or an external electronic device, and may display the one or plurality of presentation files (presentation files A, B or C as shown in FIG. 2) through a graphical user interface 131 displayed on the display 120 of the mobile device 100 for the user to select. The graphical user interface 131 is, for example, a display window, and the user may operate to move, scale up/down the display window. The computing device 110 of the mobile device 100 may receive a user command and select a first presentation file from one or a plurality of presentation files according to the user command. Then, the computing device 110 of the mobile device 100 executes the transmitter application 130 to further obtain at least one slide and speaker notes corresponding to the at least one slide from the first presentation file.

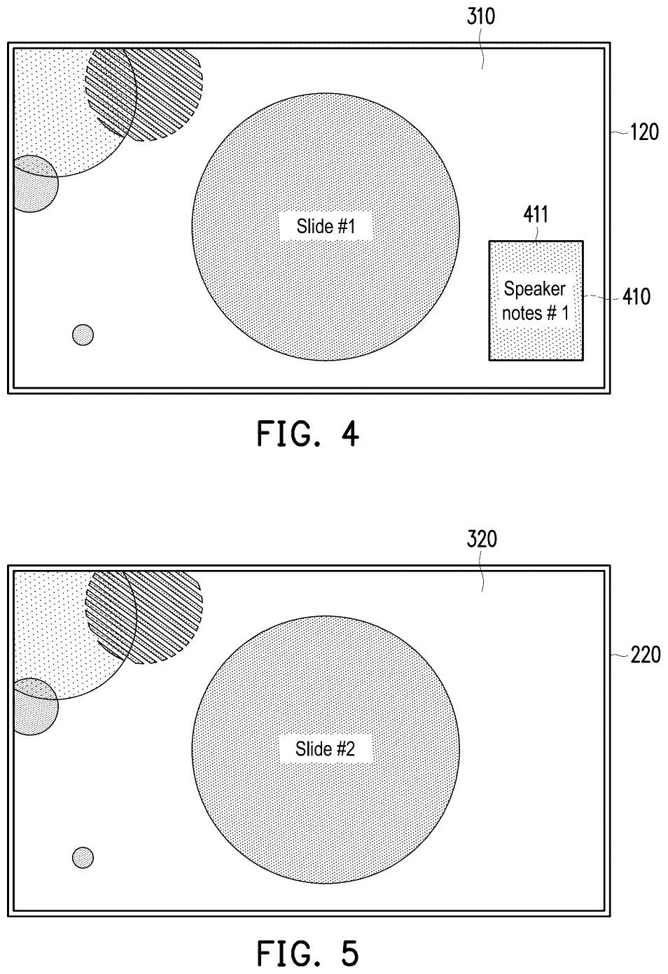

FIG. 3 is a schematic diagram of the display 220 of the display apparatus 200 displaying a slide according to an embodiment of the disclosure. FIG. 4 is a schematic diagram of the display 120 of the mobile device 100 displaying a slide and a floating window according to an embodiment of the disclosure. If the user wants to play the slide 310 of the first presentation file, the user may input the user command to the mobile device 100. In detail, the computing device 110 of the mobile device 100 executes the transmitter application 130 and is communicatively connected to the computing device 210 of the display apparatus 200 executing the receiver application 230 through the network 50. Then, the computing device 110 of the mobile device 100 may execute a screen mirroring program according to the user command. The computing device 110 of the mobile device 100 executes the transmitter application 130 for selecting a first presentation file from one or a plurality of presentation files according to the user command. The computing device 110 of the mobile device 100 executes the transmitter application 130 to transmit the slide 310 of the first presentation file to the display apparatus 200. The computing device 210 of the display apparatus 200 executes the receiver application 230 to receive the slide 310, and the display 220 of the display apparatus 200 may display the slide 310, as shown in FIG. 3. On the other hand, the computing device 110 of the mobile device 100 may control the display 120 of the mobile device 100 to display the slide 310 based on the user command, and the display 120 of the mobile device 100 further displays a floating window 410, as shown in FIG. 4. The floating window 410 at least partially covers the slide 310, and the floating window 410 may be used to display speaker notes 411 corresponding to the slide 310. In an embodiment, the floating window 410 is, for example, the topmost window, and the content in the floating window 410 will not be shielded by the slide or other windows. In addition, the user may operate the floating window 410 to move, scale up/down the floating window 410. The so-called screen mirroring program is a program used to synchronize an image displayed on the display of the mobile device to other mobile devices or display apparatuses, and regardless of a photo, a video, a game, etc., it may be displayed simultaneously on other devices or displays of display apparatuses in real-time.

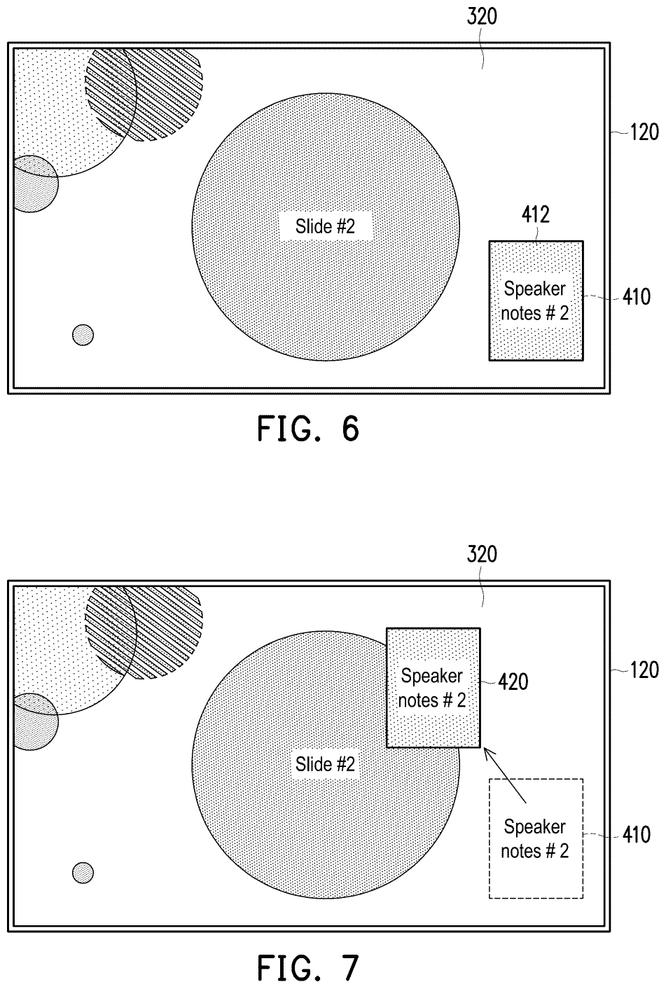

FIG. 5 is a schematic diagram of the display 220 of the display apparatus 200 displaying another slide 320 according to an embodiment of the disclosure. FIG. 6 is a schematic diagram of the display 120 of the mobile device 100 displaying another slide 320 and a floating window 410 according to an embodiment of the disclosure. If the user wants to switch the slide of the played slide of the first presentation file from the slide 310 to the slide 320, the user may input a user command to the mobile device 100 through the input interface device of the mobile device 100. The computing device 110 of the mobile device 100 executes the transmitter application 130 to transmit the slide 320 to the computing device 210 of the display device 200 according to the user command, and control the display 220 of the display apparatus 200 to switch the slide 310 to the slide 320, as shown in FIG. 5. On the other hand, the computing device 110 of the mobile device 100 executes the transmitter application 130 and may switch the slide 310 displayed on the display 120 of the mobile device 100 to the slide 320 according to the user command, and switch the speaker notes 411 displayed by the floating window 410 to the speaker notes 412 corresponding to the slide 320, as shown in FIG. 6.

The user may move a position of the floating window 410 in the display 120 of the mobile device 100. FIG. 7 is a schematic diagram of moving the floating window 410 according to an embodiment of the disclosure. If the user wants to move the floating window 410, the user may input a user command to the mobile device 100, where the user command, for example, corresponds to a drag and drop operation. The computing device 110 of the mobile device 100 may move the floating window 410 according to the user command. As shown in FIG. 6, the floating window 420 is the moved floating window 410. It is assumed that the floating window 410 that has not been moved covers a part of the slide 320, the floating window 420 may cover another part of the slide 320. A purpose of moving the floating window 420 is to prevent the speaker notes in the floating window 420 from blocking a part of the slide 320 and to allow the user to move the floating window 420 to the location where the user wants the floating window 420 to be displayed on the display 120 of the mobile device 100.

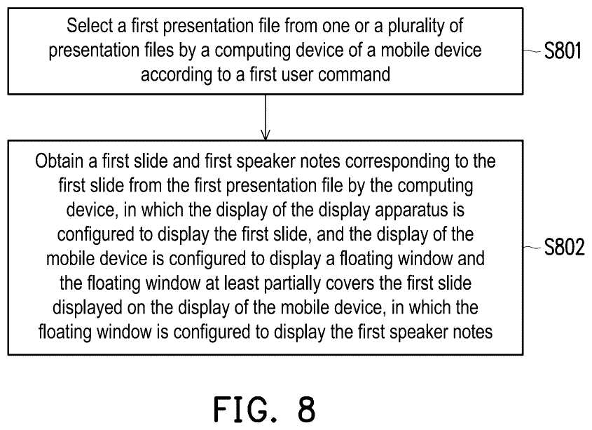

FIG. 8 is a flowchart of a display method for displaying slides according to an embodiment of the disclosure, wherein the display method may be implemented by the display system 10 shown in FIG. 1. In step S801, the computing device of the mobile device selects a first presentation file from one or a plurality of presentation files according to a first user command. In step S802, the computing device obtains a first slide and first speaker notes corresponding to the first slide from the first presentation file, where the display of the display apparatus is configured to display the first slide, and the display of the mobile device is configured to display a floating window, where the floating window at least partially covers the first slide displayed on the display of the mobile device, and the floating window is configured to display the first speaker notes.

In addition, before step S801, the display method further includes: the computing device of the mobile device executes a transmitter application, and is communicatively connected to the computing device of the display apparatus executing a receiver application through a network. Then, the computing device of the mobile device may execute a screen mirroring program according to the user command, and then step S801 of the display method is executed.

In summary, the technical problem to be solved by the disclosure is that after the mobile device and the display apparatus are communicatively connected, the mobile device executes a screen mirroring program so that the mobile device and the display apparatus display the same screen content, and therefore cannot display additional different screen content, i.e., when the display apparatus displays the slide of the mobile device, the mobile device cannot additionally display the speaker notes, and the user cannot view the speaker notes, which affects smoothness of user's speech. Therefore, the technical problem may be solved by the above-mentioned display system and display method of the disclosure.

The display system and display method of the embodiments of the disclosure have at least one of the following advantages: the mobile device of the disclosure may respectively retrieve the slides and speaker notes from the presentation files, and transmit the slides to the display apparatus. When the display device displays a slide, the mobile device may display the speaker notes through a floating window while displaying the slide. In addition, the mobile device may adjust the location of the floating window based on user's needs, allowing the user to view the speaker notes more conveniently.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the disclosure does not imply a limitation on the invention, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A display system, comprising:
a display apparatus; and
a mobile device, communicatively connected to the display apparatus through a network, wherein the mobile device comprises:
a computing device; and
a display, wherein the display is electrically connected to the computing device, the computing device is configured to select a first presentation file from at least one presentation file according to a first user command and obtain a first slide and first speaker notes corresponding to the first slide from the first presentation file, and
wherein the display apparatus is configured to display the first slide, the display is configured to display a floating window and the first slide, and the floating window at least partially covers the first slide displayed on the display, wherein the floating window is configured to display the first speaker notes.

2. The display system as claimed in claim 1, wherein the floating window covers a part of the first slide.

3. The display system as claimed in claim 2, wherein the computing device is configured to receive a second user command, and the computing device is configured to move the floating window according to the second user command, wherein the moved floating window covers another part of the first slide.

4. The display system as claimed in claim 3, wherein the second user command corresponds to a drag and drop operation.

5. The display system as claimed in claim 1, wherein the computing device is configured to obtain a second slide and second speaker notes corresponding to the second slide from the first presentation file; and the computing device is configured to receive a second user command and switch the first slide displayed on the display to the second slide and switch the first speaker notes displayed in the floating window to the second speaker notes according to the second user command.

6. The display system as claimed in claim 1, wherein the display is configured to display the first slide and the floating window, and the floating window comprises a topmost window.

7. The display system as claimed in claim 1, wherein the computing device is configured to determine whether the display apparatus and the mobile device are in the same network; and in response to the display apparatus and the mobile device being in the same network, the mobile device is configured to communicatively connect with the display apparatus.

8. A display method, adapted to a display system, wherein the display system comprises a display apparatus and a mobile device comprising a computing device and a display, the display apparatus is communicatively connected to the mobile device through a network, and the display method comprises:
selecting a first presentation file from at least one presentation file by the computing device of the mobile device according to a first user command; and
obtaining a first slide and first speaker notes corresponding to the first slide from the first presentation file,
wherein the display apparatus is configured to display the first slide, and
the display is configured to display a floating window and the first slide, the floating window at least partially covers the first slide displayed on the display, and the floating window is configured to display the first speaker notes.

9. The display method as claimed in claim 8, wherein the floating window covers a part of the first slide.

10. The display method as claimed in claim 9, further comprising:
receiving a second user command by the computing device, and
moving the floating window by the computing device according to the second user command, wherein the moved floating window covers another part of the first slide.

11. The display method as claimed in claim 10, wherein the second user command corresponds to a drag and drop operation.

12. The display method as claimed in claim 8, further comprising:
obtaining a second slide and second speaker notes corresponding to the second slide from the first presentation file by the computing device; and
receiving a second user command by the computing device, switching the first slide displayed on the display apparatus to the second slide, and switching the first speaker notes displayed in the floating window to the second speaker notes according to the second user command.

13. The display method as claimed in claim 8, wherein
the display is configured to display the first slide and the floating window, and the floating window comprises a topmost window.

14. The display method as claimed in claim 8, further comprising:
determining whether the display apparatus and the mobile device are in the same network by the computing device; and
in response to the display apparatus and the mobile device being in the same network, communicatively connecting with the display apparatus by the computing device.
